(19) United States
(12) Patent Application Publication
(10) Pub. No.: US 2009/0029082 A1
(43) Pub. Date: Jan. 29, 2009

(54) Material Web for Packagings, and Packaging Containiners

(76) Inventors: Alfred Remmele, Ochsenhausen (DE); Roland Limbeck, Biberach (DE); Bernard Lang, Ummendort (DE)

Correspondence Address: Scott R. Foster;Pandiscio & Pandescio, 470 Totten Pond Road, Waltham, MA, 02451-1914, US

(21) Appl. No.: 11/663,033

(22) PCT Filed: Sep. 19, 2005
(86) PCT No.: PCT/EP05/10086

§ 371 Date: Apr. 7, 2008

(30) Foreign Application Priority Data
Sep. 29, 2004 (DE) 10 2004 047 256.4
Apr. 2, 2005 (EP) 05007255.2
May 27, 2005 (EP) 2005/005730

(51) Int. Cl. B32B 1/08; B32B 27/08; B32B 3/24; B32B 27/32; B65B 47/00

(52) U.S. Cl. 428/35.2; 428/136; 428/35.7; 53/453

(57) ABSTRACT

In a material web (1) comprising at least two foils (14, 15) arranged one on top of the other, the foil (15) forming the outside of a packaging container (11) has slit-like openings (17) worked into it at distances from one another, and the foil (14) carrying the outer foil (15) is manufactured from a material that is elastically deformable approximately at right angles to the openings (17).

This embodiment makes it possible for the material web formed by the foils (14, 15) to be used in packagings for foodstuffs from within which a resulting excess pressure has to be dissipated in a controlled manner. The openings (17) namely increase in size according to the internal pressure and pore-like openings form in the packaging (11) and in the inner foil (14), with the effect that the excess pressure can be dissipated automatically. As a result, the eventuality of the packaging container (11) bursting during Pasteurization of a foodstuff (20) contained inside it is practically excluded.

The present invention relates to a material web composed of at least two foils arranged one on top of the other that can be used for manufacturing covering foils for packaging containers or packaging bags, for example, and to a foil packaging for foodstuffs with an excess pressure valve formed by a weak zone that opens automatically in the interior when a certain pressure is exceeded, as well as to a process for manufacturing a foil packaging in accordance with the precharacterizing clause of Patent Claim 18.

A packaging for foodstuffs that are to be subjected to Pasteurization is disclosed in EP 1 359 097 A1. The packaging that forms an air-tight seal around the foodstuff is provided with a valve in this case in order to allow at least part of the positive pressure created by heating the foodstuff in the packaging to escape to the atmosphere.

Packagings of this kind have proven themselves effective for a long period of time, although inserting the specially manufactured valves into the packaging is associated with a significant degree of complexity. In addition, the valve consists of several components such as a diaphragm held in place by webs with a sealing oil contained between the diaphragm and the body of the seal, with the result that damage when the packagings are transported and disruptions during the Pasteurization process are practically unavoidable.

A foil packaging divulged in DE 102 53 916 A1 consists of a tubular bag with a bonded seam. At least one unbonded area is provided in this, with the unbonded area extending close to the interior on one side and the other side being connected to the exterior. The steam created in the tubular bag due to heating, for example by microwaves, causes the bonded seam to open up on the way to the unbonded area, thereby forming an automatically opening excess pressure valve. An appropriate design, e.g. a tapering shape, means that the cross section for letting the steam out is kept comparatively small and that a certain vapor pressure remains in the tubular bag. This design with a weakening in the area of the closing seam means that high pressure is not created in the bag; this method requires a long heating time and means that the bag collapses after the microwave unit is switched off.

Another steam cooking bag for the microwave insert as described in DE 41 22 077 A1 can be sealed with a closing clip and has a group of punched-in or cut-in perforations on one side. During the heating process, the steam pressure causes the upper side of the bag to project outwards and the excess pressure is vented though the perforations. In this case too, the excess pressure is not very great and the bag also collapse after the microwave unit is switched off.

In a packaging for foodstuffs described in DE 695 23 751 T2, a slit is provided in a foil web and is covered by a removable membrane. Pulling off the adhesive membrane enables the slit to be exposed without opening the packaging. This also takes place automatically in a microwave device, in which the adhesive membrane is lifted as a result of the pressure increase and permits venting through the slit. There is no provision for steam pressure to build up in the packaging. During manufacture, cutting and gluing procedures are required in addition, thereby increasing the manufacturing costs.

Another process for equalizing the excess pressure during heating of ready meals involves using what is known as the Keller valve which is a piece of plastic inserted in a bag. This contains a small round piece of foil with a slit and a closed round piece of foil. The buildup of steam in the bag raises the first round piece to allow the steam pressure to escape through the slit round piece in a defined way. The disadvantage with this procedure is the very high costs of the plastic insert, which explains why the Keller valve is currently only used for large bags for catering kitchens or for very high quality ready meals. Also, installing the plastic insert itself is very complicated, which means it is not suitable for mass-market products (using the valve once cannot cover the costs involved).

Processing the foil by laser beams is a process of prior art. For example, EP 0 540 184 A1 describes how a notched line is applied to a plastic packaging by laser in order to allow it to be opened more easily. Also, a foodstuff packaging divulged in DE 697 11 704 T2 with a light-alloy middle layer provides a defined parting line manufactured by means of laser.

The purpose of the present invention is therefore to create a material web comprising at least two foils arranged one on top of the other that can be used for manufacturing packagings within which a contained foodstuff is to be subjected to a Pasteurization process, without the need for separate excess pressure valves. It should be possible for the material web to be manufactured easily and very economically, whilst nevertheless it should be possible to dissipate in a controlled manner the excess pressure resulting from heating the contained foodstuff and the packaging should seal itself with a practically air-tight seal automatically after the excess pressure has dissipated.

Furthermore, it is the purpose of the present invention to create a foil packaging that permits foodstuffs to be heated in a microwave oven exposed to the highest possible pressure for a sufficiently long period of time.

In accordance with the present invention, the material web comprising at least two foils arranged one on top of the other by means of which these purposes are to be fulfilled is characterized in that one or more slit-like openings are worked into the foil that forms the outside of a packaging container or a packaging bag, these openings running in the longitudinal and/or transverse direction of the packaging container or packaging bag and spaced with a gap in between them, and that the foil or foils carrying the foil provided with the openings is/are manufactured from a material that is elastically deformable at least at right angles to the slit-like openings.

Furthermore, this purpose is achieved by the present invention with a foil packaging having the characteristics of Claim 8. A process for manufacturing a foil packaging is specified in Claim 19. Advantageous further embodiments of the foil packaging in accordance with the present invention and the manufacturing process are the subject of the subordinated claims.

In this case, it is advantageous for the foil provided with the openings to be manufactured from a bi-axially oriented material, although it is also possible for this foil to consist of a mono-axially oriented material that is elastically deformable in the axial direction of the opening.

In accordance with a different embodiment, however, the material web can also be manufactured from a co-extruded multi-layer foil with the openings worked into layer that forms the outside of a packaging container or a bag.

It is highly advantageous for the slit-like openings to be worked into the outer foil or layer of the material web by a laser beam, this preferably occurring during the manufacturing process.

The foil consisting of a bi-axially or mono-axially oriented or co-extruded material can consist of polyester, polyamide, polypropylene or polyamide ethylene vinyl alcohol polyamide or another foil composite with an embedded layer of ethyl vinyl alcohol having a layer thickness of approx. 10-40 μm; the elastically deformable foil of the material web can consist of co-extruded polypropylene or polyethylene with a layer thickness of approx. 30-100 μm.

If a material web is configured in accordance with the present invention, it is possible to use it wholly or partially for packaging used in particular for foodstuffs within which a resulting excess pressure must be dissipated in a controlled fashion. The facts that one or more openings are worked into the outer foil, that these increase in size according to the internal pressure in the packaging and that the foil carrying these openings consists of an elastically deformable material within which pore-like openings form during expansion, namely mean that the excess pressure in the packaging can be dissipated automatically. The selection of materials, the arrangement and/or length and/or configuration of the openings allow the limits of the excess pressure to be determined, e.g. adapted in accordance with the particular Pasteurization process and the foodstuff contained.

No special components are required in order to make this possible, rather the function results from the selection of materials, therefore an extremely high level of operational reliability is guaranteed. Furthermore, it is possible to manufacture the material web in a very straightforward procedure. The openings can namely be worked into the outer layer directly during manufacture of the material web, e.g. by means of a laser beam, which means there is no need for an additional working procedure. By means of the material web configured in accordance with the present invention, it is therefore possible inexpensively to manufacture packaging containers and bags, in particular for foodstuffs that are to undergo a Pasteurization process, that offer a high level of operating reliability in allowing pressure to dissipate and consequently do not burst, whilst nevertheless not significantly impairing the barrier properties of the material web as a result of the slit-like openings.

In a foil packaging for foodstuffs in accordance with the present invention, provision is therefore made for an excess pressure valve formed by a weak zone that opens automatically when the pressure inside reaches a certain level. The foil packaging consists of at least two layers of foil, one of which includes a perforation in the form of points and/or lines created by a laser, whilst the other is closed in that area. This means the laser used for cutting is adjusted an calibrated in terms of wavelength and power so that one layer is left intact, this being the layer that seals the foodstuff packaging. The perforation in the other foil layer forms a weak point in this area. When the foodstuff is heated, the vaporization of water within the packaging gives rise to increasing pressure. The perforation line, which may be for example a slit, then opens and the other layer of foil, for example the sealing layer, is expanded with increasing pressure. The overstretching in this layer of foil results in several small openings and cracks forming, in other words the foil tears open when the elasticity limit is exceeded. The excess pressure is able to escape through the resulting small openings and an equilibrium is established between the level of excess pressure and the number or size of the holes in the foil.

The phenomenon also occurs in this case that the material in the edge zone of the holes in the second foil still possesses elasticity, which means that the openings close again or become smaller as the pressure inside the foil packaging decreases. The excess pressure valve formed in this manner is therefore a dynamic valve that opens and closes again to a certain extent depending on the pressure. In this way, it is possible for steam to escape in a controlled manner during heating of packaged ready meals in the microwave oven, whilst the dynamic behavior allows a higher pressure level to be maintained during the heating time, thereby reducing the length of the heating time. The effect of the valve is not dependent on the packaging size or the content, irrespective of whether the water content is 30 ml or 300 ml, for example. When the microwave oven is switched off again, the pressure inside the foil packaging is slowly dissipated. In contrast to conventional foil packagings with holes, the packaging does not collapse in on itself, which is an effect observable in packagings taking the form of bags.

The use of laser technology makes it very easy to provide the perforation in accordance with the present invention, without entailing additional costs, even in mass production. At the same time, this process can be integrated in existing process technology without requiring any extra working steps, for example by integrating it into a roll cutter.

Basically, the perforation formed in accordance with the present invention can be achieved in the layer of foil using a certain wavelength. It is a requirement in this case that the foil layer in the foil composite that is intended to receive the perforation must consist of a foil that absorbs the wavelength that is typical for a laser. For example, PET foil absorbs the laser light for making the perforation very well at 10.25 μm. The absorbing foil layer can also be the lower layer of foil, i.e. the laser beam passes through the uppermost layer and is separated in the layer below that because of its higher absorption. By selecting the wavelength, it is therefore possible to select the required location, i.e. the foil layer that is to be perforated.

The perforation may take the form of points and/or lines. For example, it may be a slit or a line consisting of very short lines or points, in which case the solid parts located in between must be selected to be sufficiently small as to tear during expansion of the foil, so that they do not counteract the actual effect of the valve. It is also possible to provide several perforations (slits, lines, etc.) with their contours chosen as required. The length of the slits, for example, is determined by the physical properties of the foil layer that is to be expanded, which is to say that the elasticity limit determines how the foil tears. The foil will not undergo overstretching if the slit is too short, so it will not tear, there will be no valve effect and the packaging will burst. Slits of 30 mm have been integrated in one foil layer, for example. Other slit lengths are also possible and also depend on the dimensions of the foil. Again, the slit can also be configured as an uninterrupted line along the entire packaging. In this case, however, there may be the disadvantage that the stability of the packaging is severely compromised and the barrier properties of the packaging may be severely impaired as a result. Also, the width of the slits can be set to various specific dimensions selected as required, for example by de-focusing the laser or by means of a collimator. In a preferred embodiment, the slit width is 0.1 to 3 mm, 1 to 3 mm being even more preferable.

In an advantageous embodiment of the present invention, the foil is a duplex foil with two layers, in which the sealing layer can be made from, for example, polypropylene or polyethylene and the protective foil, for example, from bi-axially oriented polyamide, polyester and SiOₓ coated polyester or mono-axially oriented vinyl polyamide, etc. The laser used is a CO₂ laser, although other lasers can also be used.

The drawing shows a material web configured in accordance with the present invention and its application in packaging containers, the details of which are explained below. In the drawing,

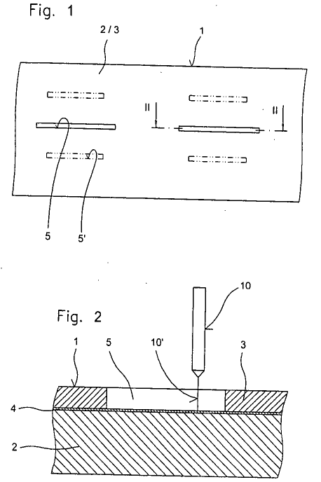

FIG. 1 shows a material web provided with slit-like openings, in a plan view,

FIG. 2 shows the material web in accordance with FIG. 1 in a section through line II-II, in a magnified view,

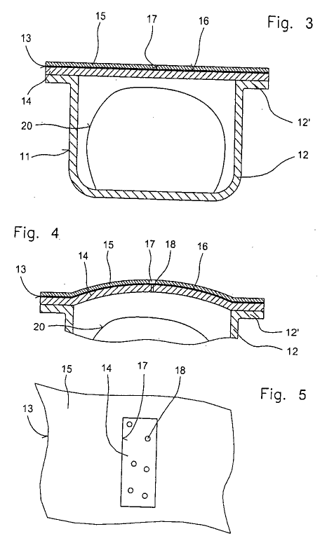

FIG. 3 shows a packaging container sealed by a material web in accordance with FIG. 1, as a section,

FIG. 4 shows the packaging container in accordance with FIG. 3 in condition of excess pressure,

FIG. 5 shows a plan view of the covering foil of the packaging container in accordance with FIG. 4, in a magnified view, and

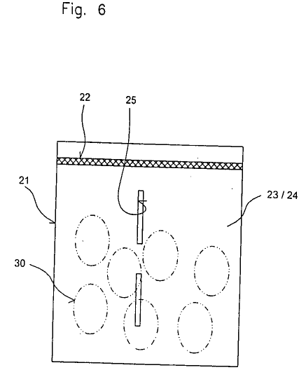

FIG. 6 shows a packaging bag manufactured using the material web in accordance with FIG. 1.

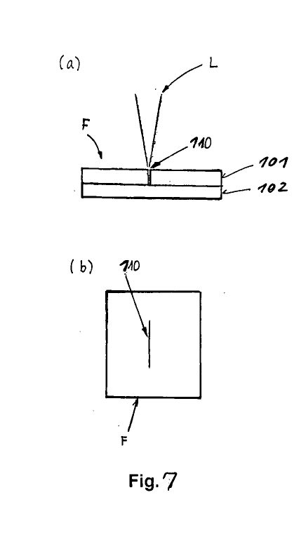

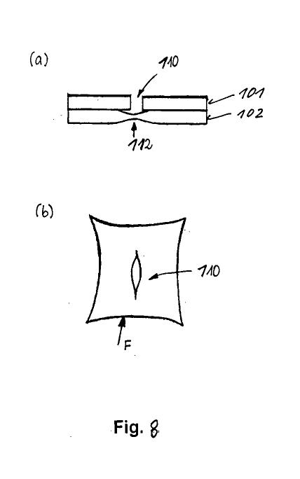

FIG. 7 shows (a) a schematic sectional view of a duplex foil packaging in accordance with the present invention and (b) a plan view of a section of the packaging clarifying how the slit is applied,

FIG. 8 shows a visualization of the opening process caused by rising pressure with expansion of the perforated foil (a) as a sectional view and (b) in plan view, of the packaging in accordance with FIG. 7,

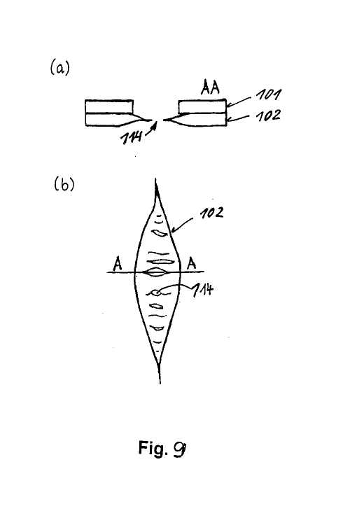

FIG. 9 shows a visualization of the overstretching process of the perforated foil (a) as a sectional view and (b) in plan view, of the packaging in accordance with FIG. 7,

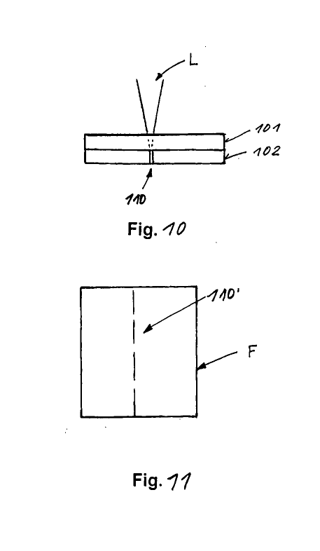

FIG. 10 shows a sectional view similar to FIG. 7, in which case however it is the lower foil that is cut,

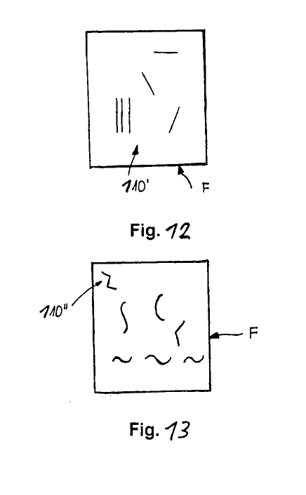

FIGS. 11 to 14 show examples of differently embodied perforations in accordance with the present invention.

The material web shown in FIGS. 1 and 2 and identified by 1 can be used, for example as shown in FIG. 3, on a covering foil 13 that can be sealed onto a packaging container 11 or, in accordance with FIG. 6, can be used as a packaging bag 21 and consists of an inner foil 2 and an outer foil 3 connected to this by means of an adhesive film 4. The inner foil 2 in this case is manufactured from an elastically deformable material whereas the outer foil 3 in the illustrated embodiment is made from a bi-axial material.

Furthermore, slit-like openings 5 are worked into the outer foil 3 one after the other at a distance from one another, although as shown by the dotted/dashed line, it is also possible to provide two or more rows of slit-like openings 5′ in the outer foil 3 adjacent to one another.

As shown in FIG. 2, the slit-like openings 5 can be worked into the outer foil 3 by a laser beam 10′ administered by a laser head 10 during manufacture of the material web 1. The material of the outer foil 3 that is abraded in this process is sucked away by means of a blower that is not illustrated.

In accordance with FIG. 3, the outer edge 12′ of the packaging container 11 configured as a bowl 12 has a covering foil 13 sealed onto it that can be produced from the material web 1 and comprises an inner foil 14 and an outer foil 15 that are firmly connected together by an adhesive layer 16. The outer foil 15 has slit-like openings 17 in it.

If the foodstuff 20 contained in the packaging container 11 is heated by a Pasteurization process, the internal pressure in the packaging container 11 increases and the covering foil 13 is expanded as shown in FIG. 4. This causes the slit-like openings 17 worked into the outer foil 15 to open because the foil 15 is not designed to expand. On the other hand, several pore-like passage openings 18 form in the inner, elastically deformable foil 14 and these passage openings 18 in the area of the openings 17 allow the excess pressure in the packaging container 12 to be dissipated because air can flow out. As soon as the excess pressure in the packaging container 12 has been dissipated, however, the covering foil 13 returns to its initial condition because of the elasticity of the inner foil 14 so that the packaging container 11 is once again provided with a practically air-tight seal.

The packaging bag 21 manufactured from a tubular foil and sealed by a sealing seam 22 in accordance with FIG. 6 operates in the same way. The inner foil 23 is manufactured from an elastically deformable material whereas the foil 24 arranged on this has a bi-axial configuration and is provided with slit-like openings 25. The foodstuff 30 container in the packaging bag 21 can therefore be heated without the risk of the packaging bag bursting as the result of excessive pressure.

FIG. 7 shows how the slit 110 is applied to the upper foil 101 of a duplex foil F by means of a laser beam L. Heating causes water contained in the foil packaging to vaporize and this results in a pressure increase, causing the slot 110 in the foil 101 to open.

This is illustrated in FIG. 8. The inflation of the packaging causes the slit 110 in the foil 101 to expand and the foil 102 underneath it is stretched. This causes a localized thin area 112 to be formed. The increase in pressure overstretches the foil 102. Small openings 114 are formed when the limit of elasticity is partially exceeded, and the foil 102 tears. The formation of the openings 114 is shown clearly in the detailed view in FIG. 9 (b).

FIG. 10 shows a similar arrangement, in which case however the foil 102 underneath is cut and the foil 101 forms the protective foil.

FIG. 11 shows a perforation line extending along the entire foil 101, but which consists of individual slits.

FIG. 12 shows an arrangement of slots 110′ in a random arrangement.

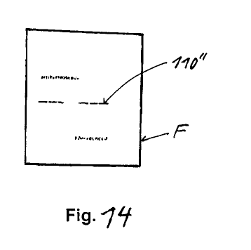

FIG. 13 makes it clean that the configuration of the slots 110″ or perforations can be selected as required, for example curved, zig-zag, arc-shaped, dog-legged, etc.

FIG. 14 illustrates slits 110″ formed by individual line sections. This indicates that the contour of the lines and slots can be selected as desired, as can their position.

1. A material web (1) comprising first and second foils (2, 3) arranged adjacent to each other and adapted to be used for manufacturing covering foils (13) for packaging containers (11) and packaging bags (21),
wherein
slit-like openings (5,5′, 17, 25) are disposed in the second foil (3, 15, 24) that forms the outside of a packaging container (11) or a packaging bag (21), these openings (5,5′, 17, 25) extending in a selected one of longitudinal and transverse directions of the packaging container (11) or packaging bag (21) and spaced with a gap therebetween, the first foil (2, 14, 23) carrying the second foil (3, 15) which is manufactured from a material that is elastically deformable at least at right angles to the slit-like openings (5,5′, 17, 25).

2. The material web in accordance with claim 1,
wherein
the second foil (3, 15, 24) material comprises a bi-axially oriented material.

3. The material web in accordance with claim 1,
wherein
the second foil (3, 15, 24) comprises a mono-axially oriented material that is elastically deformable in the axial direction of the opening (5, 5′, 17, 25).

4. The material web in accordance with claim 1,
wherein
the material web (1) comprises a co-extruded multi-layer foil with the openings (5, 5′, 17, 25) disposed in the second foil that forms the outside of the packaging container (11) or a bag (21).

5. The material web in accordance with claim 1,
wherein
the slit-like openings (5, 5′, 17, 25) are worked into the second foil (3) by a laser beam (10′) during a manufacturing process.

6. The material web in accordance with claim 1,
wherein
the second foil (3, 15, 24) comprises at least one of polyester, polyamide, polypropylene, polyamide ethylene vinyl alcohol polyamide, another foil composite with an embedded layer of ethyl vinyl alcohol having a layer thickness of approx. 10-40 μm.

7. The material web in accordance with claim 1,
wherein
the elastically deformable first foil (2, 14, 23) of the material web (1) comprises a co-extruded polypropylene or polyethylene with a layer thickness of approx. 30-100 μm.

8. A foil packaging for foodstuffs, the packaging being provided with an excess pressure valve formed by a weak zone (110) that opens automatically when a selected pressure is exceeded in the interior of the packaging,
wherein
the foil packaging comprises at least two layers of foil (101, 102), one of the layers being provided with a perforation (110) in the form of points and/or lines created by a laser (L), whilst the other layer is closed in the area of the perforation.

9. The foil packaging in accordance with claim 8,
wherein
the perforation comprises a slit.

10. The foil packaging in accordance with claim 8,
wherein the perforation comprises
a line (110′″) consisting of at least one of short lines and points.

11. The foil packaging in accordance with claim 8, wherein the weak zone comprises a plurality of perforations.

12. The foil packaging in accordance with claim 8,
wherein a first of the two foil layers comprises
a sealing layer and a second of the two foil layers comprises a protection foil.

13. The foil packaging in accordance with claim 12,
wherein
the sealing layer is made from at least one of polyethylene terephthalate (PET), vinyl polyamide (VPA), polyalpholefin (PAO), SiOₓ coated polyethylene terephthalate (PET/SiOₓ).

14. The foil packaging in accordance with claim 8,
wherein
one of said foil layers is made from a selected one of polypropylene and polyethylene.

15. The foil packaging in accordance with claim 8,
wherein
one of said foil layers is made from a selected one of bi-axially oriented polyamide, polyester and SiOₓ coated polyester, and mono-axially oriented vinyl polyamide.

16. The foil packaging in accordance with claim 8,
wherein
the foil layers form a selected one of a covering foil and a lid.

17. The foil packaging in accordance with claim 8,
wherein
the foil packaging is comprises a bag having the two foil layers.

18. The foil packaging in accordance with claim 9,
wherein
the slit is provided with a width of 1 to 2 mm.

19. A process for manufacturing a foil packaging for foodstuffs to be heated, in which a weak point integrated in the foil is adapted to opens automatically if pressure in the interior of the packaging exceeds a selected value,
wherein
two foil layers (101, 102) are used and a perforation (110) is created in one of the layers by laser light (L), the perforation comprising at least one of points and lines.

20. The process in accordance with claim 19,
wherein
a wavelength and/or power of the laser light (L) is selected for generating the perforation (110) in a selected layer of the two foil layers.
